(19) United States
(12) Patent Application Publication
(10) Pub. No.: US 2024/0177531 A1
(43) Pub. Date: May 30, 2024

(54) METHOD OF COMMUNICATING VEHICLE DATA FOR VEHICLE CONTROL

(71) Applicant: UNIONPLACE CO., LTD., Seoul (KR)

(72) Inventors: Seongcheol BANG, Seoul (KR); Hyojung KIM, Seoul (KR); Youngkyu SHIN, Seoul (KR); Seunggyeom KIM, Seoul (KR)

(73) Assignee: UNIONPLACE CO., LTD., Seoul (KR)

(21) Appl. No.: 18/470,168

(22) Filed: Sep. 19, 2023

(30) Foreign Application Priority Data
Nov. 25, 2022 (KR) 10-2022-0159998

(51) Int. Cl. G07C 5/00; H04L 9/08; H04L 9/32; H04L 9/40

(52) U.S. Cl. CPC G07C 5/008; H04L 9/0833; H04L 9/3242; H04L 63/0428

(57) ABSTRACT

There is provided a method of communicating vehicle data for vehicle control. The method includes (a) generating a multicast key and transmitting it to the vehicle in a multicast manner, (b) obtaining a hash key and an encryption key based on the multicast key and unique identification information of the vehicle, and (c) obtaining vehicle data by signal processing and combining first to n-th partition data of the vehicle data transmitted from the vehicle (“n” is an integer equal to or greater than 2). The i-th partition data includes i-th serial number information, an i-th MAC chaining value, i-th payload information, and an i-th MAC tag (“i” is an integer from 1 to n). The method further includes (c-1) receiving the i-th partition data, (c-2) authenticating the i-th partition data, and (c-3) decrypting the i-th payload information using the encryption key when the i-th partition data is authenticated.

### CROSS-REFERENCE TO RELATED PATENT APPLICATION

This non-provisional U.S. patent application is based on and claims priority under 35 U.S.C. § 119 of Korean Patent Application No. 10-2022-0159998, filed on Nov. 25, 2022, in the Korean Intellectual Property Office, the entire contents of which are hereby incorporated by reference.

### BACKGROUND

### 1. Field

The present disclosure relates to a method of communicating vehicle data for vehicle control.

The technique disclosed herein was supported by Institute for Information & communications Technology Promotion (IITP) grant funded by the Korea government (Ministry of Science and ICT (MSIT)) (Project name: “LTE-R 5G Integrated-control Container on Next Generation Railway Communication,” Project No.: 2021-0-00477-003, NIST No.: 1711193984(2023)).

### 2. Related Art

The term “vehicle” refers to an apparatus designed for transporting items or individuals, for example, transporting people or goods. Moreover, a vehicle can also encompass apparatuses used for performing tasks with occupants on board, such as agricultural or construction equipment. For instance, vehicles can be categorized into motor vehicles that include motorcycles, cars, buses, and tractors; railed vehicles that include trains operating on tracks; water vehicles that include boats and ships; amphibious vehicles capable of both land and water travel; and aerial vehicles that include drones, aircraft, and helicopters.

Inside the vehicle, numerous electronic devices can be installed. For instance, in motor vehicles such as cars, various electronic devices such as electronic control units (ECUs) and sensors are typically integrated. These multiple electronic devices within the vehicle can communicate with each other, for instance, using protocols such as a controller area network (CAN) protocol.

Due to advancements in information and communication technology as well as computing technology, especially for functionalities like autonomous driving, the number of electronic devices installed in vehicles is increasing.

A vehicle may transmit data generated by multiple electronic devices placed in the vehicle or data stored in the vehicle to an external device. Additionally, the external device may transmit data to the vehicle.

That is, the vehicle and the external device can transmit and receive vehicle data in order to control the vehicle.

Hereinafter, in the specification, data transmitted from the vehicle to the external device and data transmitted from the external device to the vehicle are collectively or individually referred to as “vehicle data.”

An example of communicating vehicle data between a car that is an example of the vehicle and the external device will be described in more detail.

For the implementation of functionalities like autonomous driving, the car may transmit vehicle data generated or stored within the car to the external device (e.g., a server operated by an entity such as a vehicle control center). Additionally, the car may receive the vehicle data such as traffic information and control information from the external device.

The car may transmit vehicle data generated within the car according to the CAN protocol to the external device using a wireless communication protocol. The external device may transmit vehicle data to the car using the wireless communication protocol.

When the car transmits vehicle data to the external device or the external device transmits vehicle data to the car, the vehicle data may be tampered with by a malicious user such as a hacker. If the tampered vehicle data is used, the car cannot drive normally and a traffic accident may occur.

To improve these shortcomings, vehicle data encrypted using an encryption key can be transmitted and received between the car and the external device.

The car and the external device share an encryption key. The car encrypts the vehicle data using the encryption key and transmits the encrypted vehicle data to the external device using a wireless communication protocol. The external device receives the encrypted vehicle data from the car using the wireless communication protocol and then decrypts the encrypted vehicle data using the shared encryption key. Afterwards, the decrypted vehicle data is interpreted.

The method using the above-described encryption key may have a high encryption level through block cipher. However, since high computing power (high computing capabilities) is required for the block cipher, there is a disadvantage in that semiconductor devices such as a central processing unit (CPU), a micro control unit (MCU), and an application specific integrated circuit (ASIC) with high computing power have to be provided in the car.

Meanwhile, if multiple cars are connected to the external device, the computing powers of the multiple cars may be different from one another. Therefore, when applying the same level of block cipher, the processing time in each car may vary, and as a result, it is difficult for individual cars to transmit vehicle data at the same processing time (or in real time). For example, among the multiple cars, a first car equipped with a semiconductor device with high computing power can transmit vehicle data in real time even when the block cipher is applied. However, a second car equipped with a semiconductor device with low computing power cannot transmit vehicle data in real time because applying block cipher increases the processing time and makes it difficult to transmit the vehicle data in real time.

Meanwhile, the multiple cars and the external device each share an encryption key. For example, the first car and the external device use a first encryption key as the encryption key, and the second car and the external device use a second encryption key as the encryption key. In that case, the external device and each of the multiple cars perform communication to share the encryption keys with each other. Therefore, in particular, as the number of cars connected to the external device increases, the communication time for sharing the encryption key between the multiple cars and the external device also increases proportionally.

### RELATED ART

### Patent document

Patent Document 1: Korean Patent Application Publication No. 10-2022-0068323

Patent Document 2: Korean Registered Patent No. 10-2334443

Patent Document 3: Korean Registered Patent No. 10-2241296

Patent Document 4: Korean Registered Patent No. 10-1967144

### SUMMARY

It is an object of the technique of the present disclosure to provide a method of communicating vehicle data for vehicle control, the method being capable of ensuring the integrity of vehicle data during transmission and reception of the vehicle data; minimizing the time for key distribution by generating a hash key and an encryption key using a multicast key; dynamically changing the hash key and the encryption key while minimizing the time for key distribution; and allowing a vehicle equipped with semiconductor devices with low computing power to communicate in real time while the vehicle data is encrypted and decrypted at an appropriate level in real time or quasi-real time.

In view of the above, according to one aspect of the technique of the present disclosure, there is provided a method of communicating vehicle data for vehicle control, which is performed by an external device, the method including: (a) generating a multicast key and transmitting the multicast key to the vehicle in a multicast manner; (b) obtaining a hash key and an encryption key based on the multicast key and unique identification information of the vehicle; and (c) obtaining vehicle data by performing signal processing on first partition data to n-th partition data consisting of the vehicle data transmitted from the vehicle and combining the first partition data to the n-th partition data (where “n” is an integer equal to or greater than 2), wherein i-th partition data among the first partition data to the n-th partition data of the vehicle data includes i-th serial number information, an i-th message authentication code (MAC) chaining value, i-th payload information, and an i-th MAC tag (where “i” is an integer from 1 to n), and (c) includes: (c-1) receiving the i-th partition data, (c-2) authenticating the i-th partition data by comparing the i-th MAC tag with an authentication value generated by computing at least the i-th MAC chaining value and the i-th payload information by using the hash key and a predetermined MAC generation algorithm, and (c-3) decrypting the i-th payload information using the encryption key when the i-th partition data is authenticated.

According to another aspect of the technique of the present disclosure, there is provided a method of communicating vehicle data for vehicle control, which is performed by a vehicle, the method including: (a) receiving a multicast key transmitted from an external device in a multicast manner; (b) obtaining a hash key and an encryption key by using the multicast key and unique identification information of the vehicle; (c) converting vehicle data into first partition data to n-th partition data by using the hash key and the encryption key (where “n” is an integer equal to or greater than 2); and (d) transmitting the first partition data to the n-th partition data to the external device, wherein i-th partition data among the first partition data to the n-th partition data of the vehicle data includes i-th serial number information, an i-th MAC chaining value, i-th payload information, and an i-th MAC tag (where “i” is an integer from 1 to n). If “i” is equal to 1, the i-th MAC chaining value is a predetermined initial value, and if “i” is not equal to 1, the i-th MAC chaining value is generated based on an (i-1)-th MAC chaining value. The i-th MAC tag is generated by computing at least the i-th MAC chaining value and the i-th payload information by using the hash key and a predetermined MAC generation algorithm, and the i-th payload information is encrypted by using the encryption key.

According to the technique of the present disclosure, it is possible to provide a method of communicating vehicle data for vehicle control, the method being capable of ensuring the integrity of vehicle data during transmission and reception of the vehicle data; minimizing the time for key distribution by generating a hash key and an encryption key using a multicast key; dynamically changing the hash key and the encryption key while minimizing the time for key distribution; and allowing a vehicle equipped with semiconductor devices with low computing power to communicate in real time while the vehicle data is encrypted and decrypted at an appropriate level in real time or quasi-real time.

### BRIEF DESCRIPTION OF THE DRAWINGS

FIG. 1 is an exemplary flow chart illustrating a method of communicating vehicle data for vehicle control according to a first embodiment of a technique of the present disclosure.

FIG. 2 is a diagram illustrating a schematic configuration of an external device in which the method of communicating vehicle data for vehicle control according to the first embodiment is performed.

FIG. 3 is a diagram illustrating an example of a system environment in which the method of communicating vehicle data for vehicle control according to the first embodiment is employed.

FIG. 4 is a diagram illustrating an example of a structure of an i-th partition data of the vehicle data in the method of communicating the vehicle data for vehicle control according to the first embodiment of the technique of the present disclosure, where “i” is an integer from 1 to n.

FIG. 5 is an exemplary flow chart illustrating the signal processing performed on the i-th partition data in the method of communicating the vehicle data for vehicle control according to the first embodiment of the technique of the present disclosure.

FIG. 6 is an exemplary flow chart illustrating a method of communicating vehicle data for vehicle control according to a second embodiment of a technique of the present disclosure.

FIG. 7 is a diagram illustrating a schematic configuration of a vehicle in which the method of communicating vehicle data for vehicle control according to the second embodiment is performed.

### DETAILED DESCRIPTION

Hereinafter, one or more embodiments (also simply referred to as “embodiments”) of a method of communicating vehicle data for vehicle control according to the technique of the present disclosure will be described mainly with reference to the drawings. Meanwhile, in the drawings for describing the embodiments of the technique of the present disclosure, for the sake of convenience of description, only a part of the practical configurations may be illustrated or the practical configurations may be illustrated while a part of the practical configurations is omitted or changed. Further, relative dimensions and proportions of parts therein may be exaggerated or reduced in size.

### First Embodiment

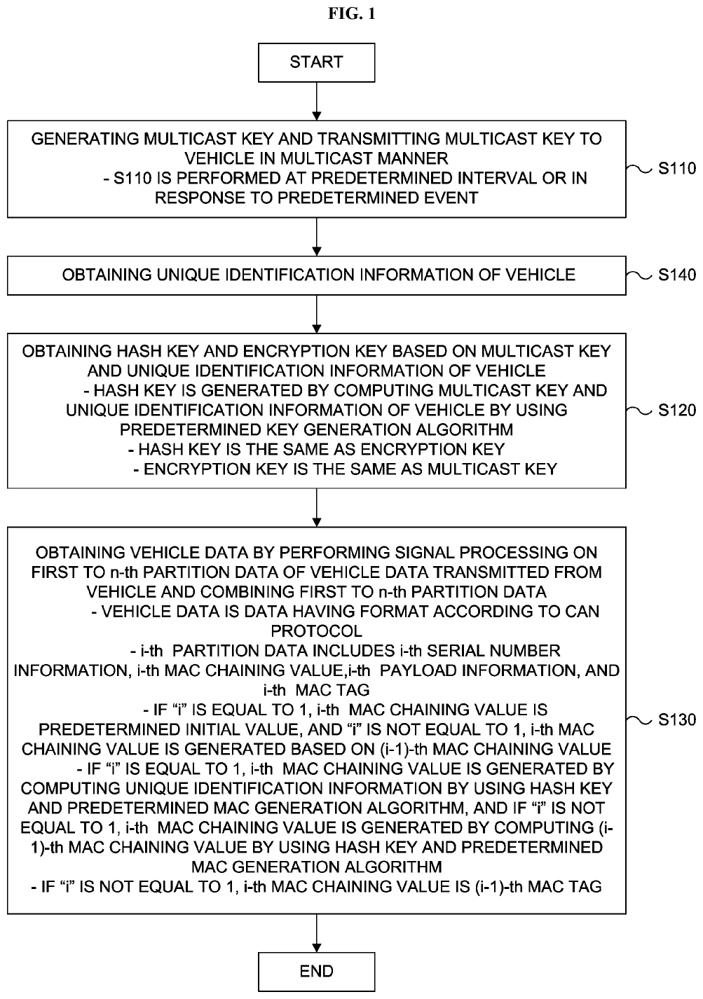

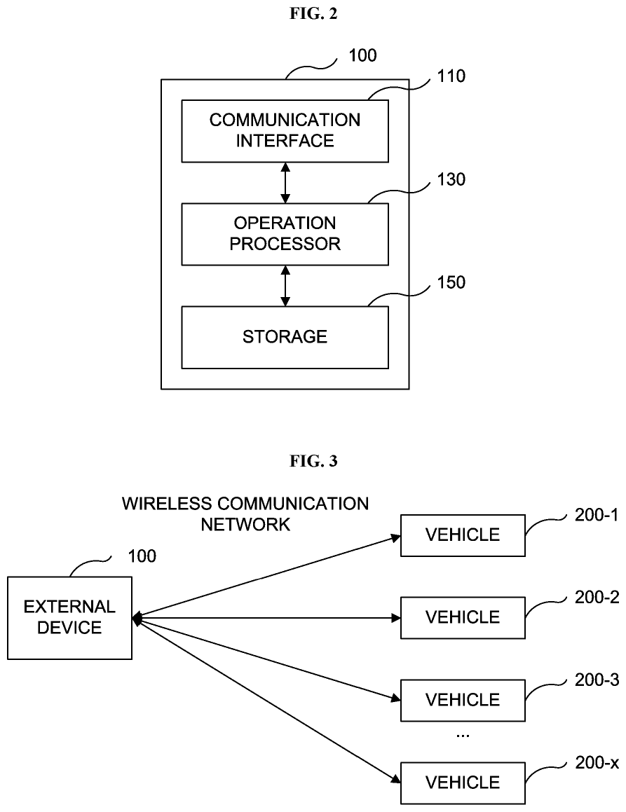

FIG. 1 is an exemplary flow chart illustrating a method of communicating vehicle data for vehicle control according to a first embodiment of a technique of the present disclosure. FIG. 2 is a diagram illustrating a schematic configuration of an external device in which the method of communicating vehicle data for vehicle control according to the first embodiment is performed. FIG. 3 is a diagram illustrating an example of a system environment in which the method of communicating vehicle data for vehicle control according to the first embodiment is employed.

With reference to FIG. 2, a description will be first given of an external device 100 that performs the method of communicating vehicle data for vehicle control according to the first embodiment of the technique of the present disclosure.

Referring to FIG. 2, the external device 100 may include a communication interface 110 and an operation processor 130, and a storage 150.

The external device 100 may be implemented, for example, using a computing device having data acquisition capabilities, computing capabilities, and communication capabilities.

The communication interface 110 is a communication interface that supports wired/wireless communications. The communication interface 110 may be implemented by a semiconductor device such as a semiconductor chip on communications. For example, the communication interface 110 may receive data in a unicast manner or a multicast manner.

The operation processor 130 may be implemented by a semiconductor device, such as a central processing unit (CPU), an application specific integrated circuit (ASIC), or the like.

The operation processor 130 may be implemented, for example, using a plurality of semiconductor devices.

For example, the operation processor 130 may be implemented using a first semiconductor device performing a control function, a second semiconductor device performing encoding/decoding of data, and a third semiconductor device performing encryption/decryption of data.

The operation processor 130 is configured to perform the method of communicating vehicle data for vehicle control according to the first embodiment, and may control the communication interface 110 and the storage 150 to execute the method of communicating vehicle data for vehicle control according to the first embodiment.

The storage 150 stores data. The storage 150 may be implemented by a semiconductor device, such as a semiconductor memory.

Next, with reference to FIG. 3, a description will be given of an example of a system environment in which the method of communicating vehicle data for vehicle control according to the first embodiment is employed.

Referring to FIG. 3, the external device 100 and a plurality of vehicles, i.e., vehicles 200-1 to 200-x, are located in the system environment. Here, x is an integer greater than or equal to 2. In the following description, the vehicles 200-1 to 200-x may also be collectively or individually referred to as a vehicle 200.

The external device 100 communicates with the vehicle 200 through a wireless communication network.

The term “external device” is used because the external device 100 is disposed outside the vehicle 200. The external device 100 may be, for example, a device operated by an entity such as a vehicle control center, serving as a server. The external device 100 may also be a device located near the road such as a road side unit (RSU) that receives vehicle data from the vehicle 200 (e.g., an automobile).

As described above, the vehicle 200 may include motor vehicles that include motorcycles, cars, buses, and tractors; railed vehicles that include trains operating on tracks; water vehicles that include boats and ships; amphibious vehicles capable of both land and water travel; and aerial vehicles that include drones, aircraft, and helicopters. For example, the vehicle 200 is an automobile (car).

An exemplary configuration of the vehicle 200 will be described later, referring to a second embodiment of the technique of the present disclosure.

Hereinafter, the method of communicating vehicle data for vehicle control according to the first embodiment of the technique of the present disclosure will be described in more detail.

Referring to FIG. 1, in step S110, the external device 100 first generates a multicast key and transmits the multicast key to the vehicle 200 in a multicast manner.

For example, the operation processor 130 of the external device 100 generates a multicast key using a predetermined key generation algorithm (not shown). The generated multicast key is collectively transmitted to the vehicle 200 (more specifically, the vehicles 200-1 to 200-x) in a multicast manner.

Instead of generating different keys and transmitting the different keys to the vehicles 200-1 to 200-x, respectively, the external device 100 generates the multicast key that can be collectively applied to the vehicles 200-1 to 200-x and transmits the generated multicast key to each of the vehicles 200-1 to 200-x. Thus, according to the first embodiment of the technique of the present disclosure, the time required for key distribution can be minimized.

Preferably, step S110 is performed at predetermined intervals or in response to predetermined events. The predetermined intervals may include, for example, one day or one week. The predetermined events may include, for example, a case of changing a hash key and an encryption key of the vehicle 200 for security reasons. For example, the external device 100 or at least one of the vehicles 200-1 to 200-x (the vehicle 200) may generate an event for changing the hash key and the encryption key of the vehicle 200, and the external device 100 may perform step S110 in response to the event. Since the external device 100 generates the multicast key at the predetermined interval or in response to the predetermined event and transmits the multicast key to the vehicle 200 in the multicast manner through step S110, the hash key and the encryption key of the vehicle 200 can be dynamically changed. Thus, the integrity and security of data between the external device 100 and the vehicle 200 can be further enhanced.

Next, in step S120, the external device 100 obtains a hash key and an encryption key based on unique identification information of the vehicle 200 and the multicast key generated in step S110.

Examples of using the hash key and the encryption key will be described later.

For example, for the vehicle 200-1, the external device 100 obtains a hash key and an encryption key applicable to the vehicle 200-1 based on unique identification information of the vehicle 200-1 and the multicast key generated in step S110. In the same manner, for each of the vehicles 200-2 to 200-x, the external device 100 obtains a hash key and an encryption key applicable to each of the vehicles 200-2 to 200-x based on unique identification information of the corresponding vehicle and the multicast key generated in step S110.

Therefore, in step S120, the external device 100 obtains the hash keys and the encryption keys to be applied to the vehicles 200-1 to 200-x, respectively.

Thus, according to the first embodiment of the technique of the present disclosure, even though the multicast key that can be collectively applied to the vehicles 200-1 to 200-x is transmitted to the vehicles 200-1 to 200-x through step S110, the hash keys and the encryption keys are respectively obtained for the vehicles 200-1 to 200-x through step S120. Accordingly, it is possible to ensure the integrity and security of the vehicle data.

The hash key of the vehicle 200 may be generated by computing the multicast key and the unique identification information of the vehicle 200 by using a predetermined key generation algorithm (also referred to as a “first predetermined key generation algorithm that takes as input the multicast key and the unique identification information of the vehicle 200.

For example, a hash key of the vehicle 200-1 is generated by computing the multicast key and the unique identification information of the vehicle 200-1 by using a first predetermined key generation algorithm that takes as input the multicast key and the unique identification information of the vehicle 200-1. In the same manner, a hash key of each of the vehicles 200-2 to 200-x is generated by computing the multicast key and the unique identification information of the corresponding vehicle by using the first predetermined key generation algorithm that takes as input the multicast key and the unique identification information of the corresponding vehicle.

The encryption key of the vehicle 200 may be the same as the hash key of the vehicle 200.

For example, an encryption key of the vehicle 200-1 may be the same as the hash key of the vehicle 200-1. In the same manner, encryption keys of the vehicles 200-2 to 200-x may be the same as the hash keys of the vehicles 200-2 to 200-x, respectively.

Alternatively, the encryption key of the vehicle 200 may be the same as the multicast key.

That is, the multicast key may be used as the encryption key of each of the vehicles 200-1 to 200-x. However, in that case, the encryption keys of the vehicles 200-1 to 200-x are the same, which decreases the security of data.

In order to increase the security, the encryption key of the vehicle 200 is preferably the same as the hash key of the vehicle 200.

Alternatively, in order to further increase (enhance) the security, the encryption key of the vehicle 200 may be generated by using a second predetermined key generation algorithm that is different from the first predetermined key generation algorithm used to generate the hash key described above. However, it is preferred that the encryption key of the vehicle 200 is the same as the hash key of the vehicle 200, particularly in view of the computing power (computing capabilities) of the vehicle 200.

Alternatively, the encryption key of the vehicle 200 may be generated by computing the multicast key and identification information of the vehicle 200 (which is different from the unique identification information described above) by using the first predetermined key generation algorithm that is used to generate the hash key described above, the first predetermined key generation algorithm taking as input the multicast key and the identification information of the vehicle 200. The identification information of the vehicle 200 may be stored in advance, for example, in the external device 100.

Next, in step S130, the external device 100 performs signal processing on first to n-th partition data consisting of the vehicle data transmitted from the vehicle 200 and combines the first to n-th partition data to obtain the complete vehicle data. Here, “n” is an integer equal to or greater than 2.

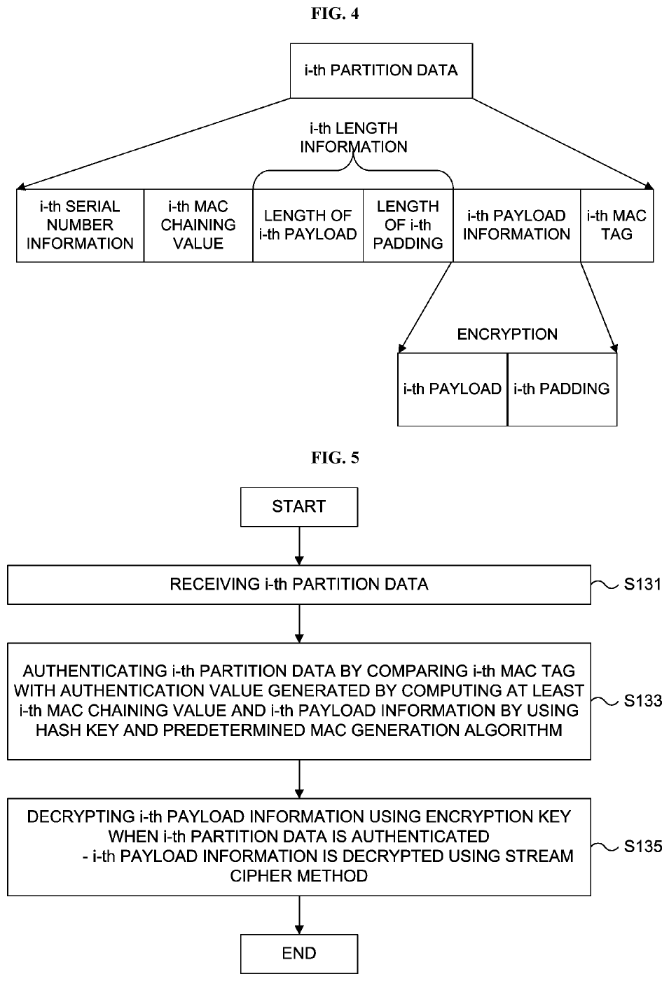

FIG. 4 is a diagram illustrating an example of a structure of an i-th partition data of the vehicle data in the method of communicating the vehicle data for vehicle control according to the first embodiment of the technique of the present disclosure, where “i” is an integer from 1 to n.

Referring to FIG. 4, the i-th partition data among the first to n-th partition data of the vehicle data includes i-th serial number information, an i-th message authentication code (MAC) chaining value, i-th payload information, and an i-th MAC tag. The i-th partition data may further include i-th length information.

It will be apparent to those skilled in the art that the structure of the i-th partition data illustrated in FIG. 4, is merely an example, and may be modified in various ways.

The i-th serial number information is information indicating the order of the i-th partition data. For example, the serial number of the first partition data (i.e., first serial number information) may be designated as “1,” the serial number of the second partition data (i.e., second serial number information) may be designated as “2,” and the serial number of the n-th partition data (i.e., n-th serial number information) may be designated as “n.”

The i-th MAC chaining value serves as information for authenticating the order of the i-th partition data.

The i-th length information (more specifically, a length of an i-th payload and a length of an i-th padding) is information including the length of the i-th payload and the length of the i-th padding corresponding to the i-th payload information in the i-th partition data.

The i-th payload information includes the i-th payload and the i-th padding. The i-th payload information may include the i-th payload only. As will be described later, the i-th payload (and the i-th padding) is encrypted and designated as the i-th payload information.

The i-th payload is a partitioned portion of the vehicle data, and the vehicle data may be, for example, data having a format according to the controller area network (CAN) protocol.

The i-th MAC tag serves as information for authenticating the integrity of the i-th partition data.

FIG. 5 is an exemplary flow chart illustrating the signal processing performed on the i-th partition data in the method of communicating the vehicle data for vehicle control according to the first embodiment of the technique of the present disclosure.

First, in step S131, the external device 100 receives the i-th partition data. For example, the external device 100 receives the i-th partition data of the vehicle data transmitted from the vehicle 200.

Next, in step S133, the external device 100 authenticates the i-th partition data by comparing the i-th MAC tag with an authentication value generated by computing at least the i-th MAC chaining value and the i-th payload information by using the hash key and a predetermined MAC generation algorithm that takes as input at least the i-th MAC chaining value and the i-th payload information.

In the case where the i-th partition data further includes the i-th length information, it is preferable that the authentication value is generated by computing the i-th MAC chaining value, the i-th length information, and the i-th payload information by using the hash key and the predetermined MAC generation algorithm that takes as input the i-th MAC chaining value, the i-th length information, and the i-th payload information.

Specifically, the external device 100 extracts the i-th serial number information, the i-th MAC chaining value, the i-th payload information, and the i-th MAC tag (and the i-th length information) from the i-th partition data received in step S131, and then generates the authentication value. Thereafter, the i-th MAC tag is compared with the authentication value.

As described above, the i-th serial number information indicates the order of the i-th partition data.

If “i” is equal to 1, the i-th MAC chaining value is a predetermined initial value. If “i” is not equal to 1, the i-th MAC chaining value is generated based on an (i-1)-th MAC chaining value.

For example, if “i” is equal to 1, the i-th MAC chaining value may be generated by computing the unique identification information of the vehicle 200 by using the hash key and the MAC generation algorithm that takes as input the unique identification information of the vehicle 200, and if “i” is not equal to 1, the i-th MAC chaining value may be generated by computing the (i-1)-th MAC chaining value by using the hash key and the MAC generation algorithm that takes as input the (i-1)-th MAC chaining value.

Alternatively, if “i” is not equal to 1, the i-th MAC chaining value may use the (i-1)-th MAC tag.

The i-th MAC chaining value generated as described above is included in advance in the i-th partition data.

The i-th MAC tag is generated by computing at least the i-th MAC chaining value and the i-th payload information by using the hash key and the MAC generation algorithm that takes as input at least the i-th MAC chaining value and the i-th payload information.

In the case where the i-th partition data further includes the i-th length information, it is preferable that the i-th MAC tag is generated by computing the i-th MAC chaining value, the i-th length information, and the i-th payload information by using the hash key and the MAC generation algorithm that takes as input the i-th MAC chaining value, the i-th length information, and the i-th payload information.

The i-th MAC tag generated as described above is included in advance in the i-th partition data.

Accordingly, the external device 100 may authenticate the integrity of the i-th partition data by comparing the i-th MAC tag included in the i-th partition data with the authentication value generated as described above.

In addition, by using the i-th MAC chaining value, the integrity and the order of the first to n-th partition data can be authenticated. That is, if “i” is not equal to 1, the (i-1)-th MAC chaining value of the (i-1)-th partition data, which is the data immediately preceding the i-th partition data in order, is used to generate the i-th MAC chaining value, so that the integrity and the order of the i-th partition data can be authenticated.

Next, in step S135, when the i-th partition data is authenticated, the external device 100 decrypts the i-th payload information using the encryption key.

As described above, the i-th payload information may include the encrypted i-th payload and the encrypted i-th padding.

Accordingly, the external device 100 decrypts the i-th payload information using the encryption key and extracts the i-th payload and the i-th padding.

The i-th payload and the i-th padding may be encrypted using, for example, a block cipher method. However, when the same level of block cipher is applied to the vehicle 200, more specifically to each of the vehicles 200-1 to 200-x, the processing time in each of the vehicles 200-1 to 200-x may vary. As a result, it is difficult for each of the vehicles 200-1 to 200-x to transmit vehicle data at the same processing time (or in real time).

Therefore, the vehicle 200, more specifically, each of the vehicles 200-1 to 200-x may use, for example, a stream cipher method to quickly encrypt the i-th payload information while still providing an appropriate level of encryption. In this case, the external device 100 may decrypt the i-th payload information using the stream cipher method.

Referring back to FIG. 1, in step S140, the external device 100 may obtain the unique identification information of the vehicle 200 prior to step S120.

The unique identification information of the vehicle 200 may include, for example, a vehicle identification number assigned to the vehicle 200. For example, the external device 100 may receive the unique identification information of the vehicle 200 from the vehicle 200, or the external device 100 may store the unique identification information of the vehicle 200 in the process of registering the vehicle 200 with the external device 100.

As described above, according to the first embodiment of the technique of the present disclosure, the external device 100 transmits the multicast key to the plurality of vehicles 200 in the multicast manner, thereby minimizing the time required to distribute the key to each of the plurality of vehicles 200. Further, the external device 100 may use the multicast key and pieces of unique identification information of the plurality of vehicles 200 to generate a plurality of hash keys and a plurality of encryption keys that are applied to the plurality of vehicles 200, respectively, thereby preventing forgery or tampering during transmission or reception of vehicle data. Additionally, the hash key and the encryption key applied to the vehicle 200 may be changed dynamically while minimizing the time for key distribution. Furthermore, even when utilizing the stream cipher method, a vehicle having a semiconductor device with low computing power may be able to encrypt and decrypt the vehicle data to an appropriate level in real-time or quasi-real-time, and transmit the vehicle data to the external device 100 in real-time or quasi-real-time. Thus, the external device 100 may receive the vehicle data in real-time or quasi-real-time.

### Second Embodiment

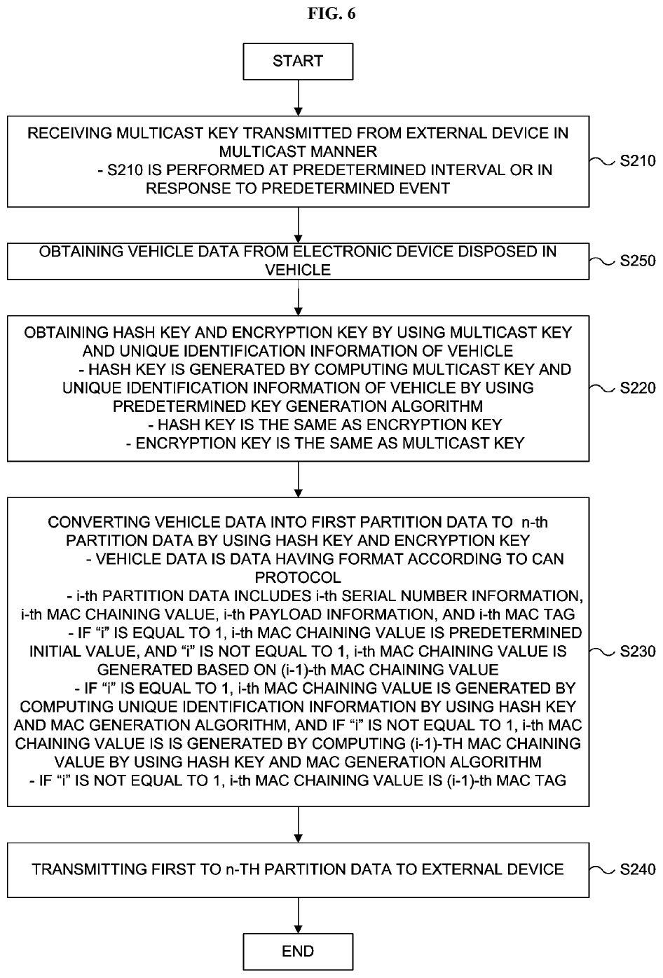

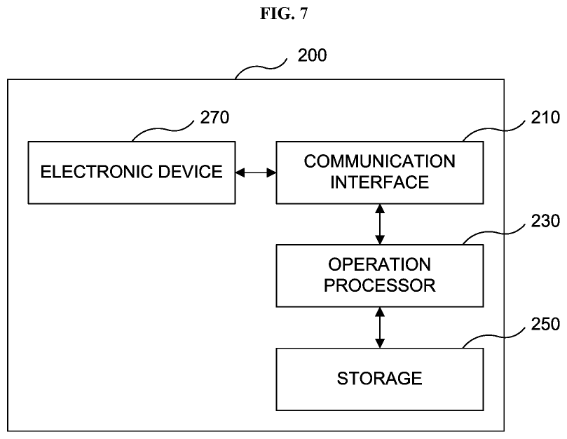

FIG. 6 is an exemplary flow chart illustrating a method of communicating vehicle data for vehicle control according to a second embodiment of a technique of the present disclosure. FIG. 7 is a diagram illustrating a schematic configuration of a vehicle in which the method of communicating vehicle data for vehicle control according to the second embodiment is performed.

With reference to FIG. 7, a description will be first given of the vehicle 200 that performs the method of communicating vehicle data for vehicle control according to the second embodiment of the technique of the present disclosure.

Referring to FIG. 7, the vehicle 200 may include a communication interface 210 and an operation processor 230, and a storage 250.

The vehicle 200 may be implemented, for example, using a computing device having data acquisition capabilities, computing capabilities, and communication capabilities.

The communication interface 210 is a communication interface that supports wired/wireless communications. The communication interface 210 may be implemented by a semiconductor device such as a semiconductor chip on communications. For example, the communication interface 210 may receive data in a unicast manner or a multicast manner.

The operation processor 230 may be implemented by a semiconductor device, such as a central processing unit (CPU), a microcontroller unit (MCU), an application specific integrated circuit (ASIC), or the like.

The operation processor 230 may be implemented, for example, using a plurality of semiconductor devices.

For example, the operation processor 230 may be implemented using a first semiconductor device performing a control function, a second semiconductor device performing encoding/decoding of data, and a third semiconductor device performing encryption/decryption of data.

The operation processor 230 is configured to perform the method of communicating vehicle data for vehicle control according to the second embodiment, and may control the communication interface 210 and the storage 250 to execute the method of communicating vehicle data for vehicle control according to the second embodiment.

The storage 250 stores data. The storage 250 may be implemented by a semiconductor device, such as a semiconductor memory.

Further, the vehicle 200 may obtain the vehicle data from an electronic device 270 disposed inside the vehicle 200.

The electronic device 270 is, for example, a devices such as an electronic control unit (ECU), a sensor, and the like.

The vehicle data is data having a format according to the CAN protocol, for example.

A system environment, in which the method of communicating vehicle data for vehicle control according to the second embodiment of the technique of the present disclosure is employed, is substantially the same as the system environment, in which the method of communicating vehicle data for vehicle control according to the first embodiment described, for example, with reference to FIG. 3. Therefore, a detailed description thereof will be omitted.

Hereinafter, the method of communicating vehicle data for vehicle control according to the second embodiment of the technique of the present disclosure will be described in more detail.

Referring to FIG. 6, in step S210, the vehicle 200 first receives the multicast key transmitted in the multicast manner from the external device 100.

As described in the method of communicating vehicle data for vehicle control according to the first embodiment, the external device 100 generates the multicast key using the predetermined key generation algorithm (first predetermined key generation algorithm) and transmits the generated multicast key to the vehicle 200. The vehicle 200 receives the multicast key through step S210.

Preferably, step S210 is performed at predetermined intervals or in response to predetermined events. The predetermined intervals may include, for example, one day or one week. The predetermined events may include, for example, a case of changing a hash key and an encryption key of the vehicle 200 for security reasons. For example, at least one of the vehicle and the external device 100 may generate an event for changing the hash key and the encryption key of the vehicle 200, and the vehicle 200 may perform step S210 in response to the event. Since the vehicle 200 receives the multicast key at the predetermined interval or in response to the predetermined event, the hash key and the encryption key of the vehicle 200 can be dynamically changed, which will be described later. Thus, the integrity and security of data between the external device 100 and the vehicle 200 can be further enhanced.

Next, in step S220, the vehicle 200 obtains a hash key and an encryption key based on unique identification information of the vehicle 200 and the multicast key received through step S210.

That is, in the substantially same manner as the method of communicating vehicle data for vehicle control according to the first embodiment, the vehicle 200 uses the multicast key received through step S210 and the unique identification information of the vehicle 200 to obtain the hash key and the encryption key of the vehicle 200.

The key generation algorithm used in step S220 is the same as the first predetermined key generation algorithm used in step S120.

Therefore, the vehicle 200 and the external device 100 share the same hash key and the same encryption key.

More specifically, the vehicle 200-1 and the external device 100 share a hash key and an encryption key of the vehicle 200-1, and the vehicle 200-2 and the external device 100 share a hash key and an encryption key of the vehicle 200-2 that are different from the hash key and the encryption key of the vehicle 200-1, respectively. Similarly, the vehicle 200-x and the external device 100 share a hash key and an encryption key of the vehicle 200-x that are different from the hash key and the encryption key of the vehicle 200-1 and the hash key and the encryption key of the vehicle 200-2, respectively.

Accordingly, the vehicles 200-1 to 200-x may communicate with the external device 100 using different hash keys and different encryption keys.

The hash key of the vehicle 200 may be generated by computing the multicast key and the unique identification information of the vehicle 200 by using the first predetermined key generation algorithm that takes as input the multicast key and the unique identification information of the vehicle 200.

The encryption key of the vehicle 200 may be the same as the hash key of the vehicle 200.

Alternatively, the encryption key of the vehicle 200 may be the same as the multicast key.

That is, the multicast key may be used as the encryption key of the vehicle 200.

However, in order to increase the security, the encryption key of the vehicle 200 is preferably the same as the hash key of the vehicle 200.

Alternatively, in order to further increase (enhance) the security, the encryption key of the vehicle 200 may be generated by using a second predetermined key generation algorithm that is different from the first predetermined key generation algorithm used to generate the hash key described above. However, it is preferred that the encryption key of the vehicle 200 is the same as the hash key of the vehicle 200, particularly in view of the computing power (computing capabilities) of the vehicle 200.

Alternatively, the encryption key of the vehicle 200 may be generated by computing the multicast key and identification information of the vehicle 200 (which is different from the unique identification information described above) by using the first predetermined key generation algorithm that is used to generate the hash key described above, the first predetermined key generation algorithm taking as input the multicast key and the identification information of the vehicle 200. The identification information of the vehicle 200 may include, for example, a vehicle identification number assigned to the vehicle 200. The identification information of the vehicle 200 may be stored in advance in the storage 250 of the vehicle 200.

Next, in step S230, the vehicle 200 utilizes the hash key and the encryption key obtained in step S220 to convert the vehicle data into first to n-th partition data where “n” is an integer equal to or greater than 2.

The i-th partition data among the first to n-th partition data of the vehicle data includes i-th serial number information, an i-th MAC chaining value, i-th payload information, and an i-th MAC tag where “i” is an integer from 1 to n. The i-th partition data may further include i-th length information.

The i-th serial number information is information indicating the order of the i-th partition data. For example, the serial number of the first partition data (i.e., first serial number information) may be designated as “1,” the serial number of the second partition data (i.e., second serial number information) may be designated as “2,” and the serial number of the n-th partition data (i.e., n-th serial number information) may be designated as “n.”

The i-th MAC chaining value serves as information for authenticating the order of the i-th partition data.

The i-th length information (more specifically, a length of an i-th payload and a length of an i-th padding) is information including the length of the i-th payload and the length of the i-th padding corresponding to the i-th payload information in the i-th partition data.

The i-th payload information includes the i-th payload and the i-th padding. The i-th payload information may include the i-th payload only. The i-th payload (and the i-th padding) is encrypted and designated as the i-th payload information.

The i-th payload is a partitioned portion of the vehicle data, and the vehicle data may be, for example, data having a format according to the CAN protocol.

The i-th payload and the i-th padding may be encrypted using, for example, a block cipher method. However, when the same level of block cipher is applied to the vehicle 200, more specifically to each of the vehicles 200-1 to 200-x, the processing time in each of the vehicles 200-1 to 200-x may vary. As a result, it is difficult for each of the vehicles 200-1 to 200-x to transmit vehicle data at the same processing time (or in real time).

Therefore, the vehicle 200, more specifically, each of the vehicles 200-1 to 200-x may use, for example, a stream cipher method to quickly encrypt the i-th payload information while still providing an appropriate level of encryption. In this case, the external device 100 may decrypt the i-th payload information using the stream encryption method.

The i-th MAC tag serves as information for authenticating the integrity of the i-th partition data.

The i-th partition data in the method of communicating vehicle data for vehicle control according to the second embodiment is the same as the i-th partition data in the method of communicating vehicle data for vehicle control according to the first embodiment.

As described above, the i-th serial number information indicates the order of the i-th partition data.

If “i” is equal to 1, the i-th MAC chaining value is a predetermined initial value. If “i” is not equal to 1, the i-th MAC chaining value is generated based on an (i-1)-th MAC chaining value.

For example, if “i” is equal to 1, the i-th MAC chaining value may be generated by computing the unique identification information of the vehicle 200 by using the hash key and the MAC generation algorithm that takes as input the unique identification information of the vehicle 200, and if “i” is not equal to 1, the i-th MAC chaining value may be generated by computing the (i-1)-th MAC chaining value by using the hash key and the MAC generation algorithm that takes as input the (i-1)-th MAC chaining value.

Alternatively, if “i” is not equal to 1, the i-th MAC chaining value may use the (i-1)-th MAC tag.

The i-th MAC chaining value generated as described above is included in the i-th partition data.

The i-th MAC tag is generated by computing at least the i-th MAC chaining value and the i-th payload information by using the hash key and the MAC generation algorithm that takes as input at least the i-th MAC chaining value and the i-th payload information.

In the case where the i-th partition data further includes the i-th length information, it is preferable that the i-th MAC tag is generated by computing the i-th MAC chaining value, the i-th length information, and the i-th payload information by using the hash key and the MAC generation algorithm that takes as input the i-th MAC chaining value, the i-th length information, and the i-th payload information.

The i-th MAC tag generated as described above is included in the i-th partition data.

Accordingly, as described above, when the external device 100 receives the i-th partition data, the external device 100 may authenticate the integrity of the i-th partition data by comparing the i-th MAC tag included in the i-th partition data with an authentication value generated by computing the i-th payload information by using the hash key and a predetermined MAC generation algorithm that takes as input the i-th payload information.

Next, in step S240, the vehicle 200 transmits the first to n-th partition data converted in step S230 to the external device 100. For example, the vehicle 200 transmits the first to n-th partition data using a wireless communication protocol.

Referring back to FIG. 6, in step S250, the vehicle 200 may obtain the vehicle data from the electronic device 270 disposed inside the vehicle 200 prior to step S220.

The vehicle data is generated by the electronic device 270 such as an ECU, a sensor, or the like and may be data that has a format according to the CAN protocol.

As described above, according to the second embodiment of the technique of the present disclosure, the vehicle 200 receives the multicast key from the external device 100 in the multicast manner, and generates the hash key and the encryption key to be applied to the vehicle 200 by using the multicast key and unique identification information of the vehicle 200. By utilizing the hash key and the encryption key to be applied to the vehicle 200, it may be possible to prevent forgery or tampering during transmission or reception of vehicle data. Additionally, the hash key and the encryption key applied to the vehicle 200 may be changed dynamically while minimizing the time for key distribution. Furthermore, even when utilizing the stream cipher method, the vehicle 200 having a semiconductor device with low computing power can also encrypt and decrypt the vehicle data to an appropriate level in real-time or quasi-real-time, and transmit the vehicle data to the external device 100 in real-time or quasi-real-time. Thus, the external device 100 may receive the vehicle data in real-time or quasi-real-time.

### Other Embodiments

While the technique of the present disclosure is described in detail by way of the embodiments described above, the technique of the present disclosure is not limited thereto and may be modified in various ways without departing from the scope thereof.

For example, the technique of the present disclosure has been described based on an example in which the vehicle 200 transmits vehicle data and the external device 100 receives the vehicle data. However, it is equally applicable, for example, when the external device 100 transmits the vehicle data and the vehicle 200 receives the vehicle data.

That is, after generating the hash key and the encryption key of the vehicle 200 based on the multicast key, the technique of the present disclosure may be applied even when the external device 100 transmits the vehicle data and the vehicle 200 receives the vehicle data using the hash key and the encryption key of the vehicle 200.

Furthermore, the technique of the present disclosure has been described based on an example of calculating a MAC tag after the vehicle data (partition data) is encrypted. However, the technique of the present disclosure is not limited thereto. The technique of the present disclosure may also be employed, for example, when the vehicle data (partition data) is encrypted after the MAC tag of the vehicle data (partition data) is calculated.

For example, the technique of the present disclosure may be applied to an external device including an operation processor that is configured to (a) generate a multicast key and transmit the multicast key to the vehicle in a multicast manner; (b) obtain a hash key and an encryption key based on the multicast key and unique identification information of the vehicle; and (c) obtain vehicle data by performing signal processing on first partition data to n-th partition data consisting of the vehicle data transmitted from the vehicle and combine the first partition data to the n-th partition data (where “n” is an integer equal to or greater than 2), wherein i-th partition data among the first partition data to the n-th partition data of the vehicle data includes i-th serial number information, an i-th message authentication code (MAC) chaining value, i-th payload information, and an i-th MAC tag (where “i” is an integer from 1 to n), and (c) includes: (c-1) receiving the i-th partition data, (c-2) authenticating the i-th partition data by comparing the i-th MAC tag with an authentication value generated by computing at least the i-th MAC chaining value and the i-th payload information by using the hash key and a predetermined MAC generation algorithm that takes as input at least the i-th MAC chaining value and the i-th payload information, and (c-3) decrypting the i-th payload information using the encryption key when the i-th partition data is authenticated.

As another example, the technique of the present disclosure may be applied to a vehicle including an operation processor that is configured to (a) receive a multicast key transmitted from an external device in a multicast manner; (b) obtain a hash key and an encryption key by using the multicast key and unique identification information of the vehicle; (c) concert vehicle data into first partition data to n-th partition data by using the hash key and the encryption key (where “n” is an integer equal to or greater than 2); and (d) transmit the first partition data to the n-th partition data to the external device, wherein i-th partition data among the first partition data to the n-th partition data of the vehicle data includes i-th serial number information, an i-th MAC chaining value, i-th payload information, and an i-th MAC tag (where “i” is an integer from 1 to n). If “i” is equal to 1, the i-th MAC chaining value is a predetermined initial value, and if “i” is not equal to 1, the i-th MAC chaining value is generated based on an (i-1)-th MAC chaining value. The i-th MAC tag is generated by computing at least the i-th MAC chaining value and the i-th payload information by using the hash key and a predetermined MAC generation algorithm that takes as input at least the i-th MAC chaining value and the i-th payload information, and the i-th payload information is encrypted by using the encryption key.

Accordingly, the exemplary embodiments disclosed herein are not used to limit the technical idea of the present disclosure, but to explain the present disclosure, and the scope of the technical idea of the present disclosure is not limited by those embodiments. Therefore, the scope of protection of the present disclosure should be construed as defined in the following claims, and all technical ideas that fall within the technical idea of the present disclosure are intended to be embraced by the scope of the claims of the present disclosure.

### INDUSTRIAL APPLICABILITY

According to the embodiments of the technique of the present disclosure, the integrity of vehicle data is ensured during transmission and reception of the vehicle data; the time for key distribution is minimized by generating a hash key and an encryption key using a multicast key; the hash key and the encryption key are dynamically changed while minimizing the time for key distribution; and a vehicle equipped with semiconductor devices with low computing power performs communications in real time while the vehicle data is encrypted and decrypted at an appropriate level in real time or quasi-real time.

What is claimed is:

1. A method of communicating vehicle data for vehicle control, which is performed by an external device, the method comprising:
(a) generating a multicast key and transmitting the multicast key to the vehicle in a multicast manner;
(b) obtaining a hash key and an encryption key based on the multicast key and unique identification information of the vehicle; and
(c) obtaining vehicle data by performing signal processing on first partition data to n-th partition data consisting of the vehicle data transmitted from the vehicle and combining the first partition data to the n-th partition data, wherein “n” is an integer equal to or greater than 2,
wherein i-th partition data among the first partition data to the n-th partition data of the vehicle data includes i-th serial number information, an i-th message authentication code (MAC) chaining value, i-th payload information, and an i-th MAC tag, wherein “i” is an integer from 1 to n, and
wherein (c) comprises:
(c-1) receiving the i-th partition data,
(c-2) authenticating the i-th partition data by comparing the i-th MAC tag with an authentication value generated by computing at least the i-th MAC chaining value and the i-th payload information by using the hash key and a predetermined MAC generation algorithm, and
(c-3) decrypting the i-th payload information using the encryption key when the i-th partition data is authenticated.

2. The method of claim 1, further comprising:
(d) obtaining the unique identification information of the vehicle prior to (b).

3. The method of claim 1, wherein if “i” is equal to 1, the i-th MAC chaining value is a predetermined initial value, and if “i” is not equal to 1, the i-th MAC chaining value is generated based on an (i-1)-th MAC chaining value.

4. The method of claim 1, wherein if “i” is equal to 1, the i-th MAC chaining value is generated by computing the unique identification information by using the hash key and the predetermined MAC generation algorithm, and if “i” is not equal to 1, the i-th MAC chaining value is generated by computing an (i-1)-th MAC chaining value by using the hash key and the predetermined MAC generation algorithm.

5. The method of claim 1, wherein if “i” is not equal to 1, the i-th MAC chaining value is an (i-1)-th MAC tag.

6. The method of claim 1, wherein, in (c-3), the i-th payload information is decrypted using a stream cipher method.

7. The method of claim 1, wherein the i-th payload information includes an i-th payload and an i-th padding that are being encrypted,
the i-th partition data further includes i-th length information that includes a length of the i-th payload and a length of the i-th padding, and
the authentication value is generated by computing the i-th MAC chaining value, the i-th length information, and the i-th payload information by using the hash key and the predetermined MAC generation algorithm.

8. The method of claim 1, wherein the vehicle data is data having a format according to a controller area network (CAN) protocol.

9. The method of claim 1, wherein, in (b), the hash key is generated by computing the multicast key and the unique identification information of the vehicle by using a predetermined key generation algorithm.

10. The method of claim 1, wherein the hash key is the same as the encryption key.

11. The method of claim 1, wherein (a) is performed at a predetermined interval or in response to a predetermined event.

12. A method of communicating vehicle data for vehicle control, which is performed by a vehicle, the method comprising:
(a) receiving a multicast key transmitted from an external device in a multicast manner;
(b) obtaining a hash key and an encryption key by using the multicast key and unique identification information of the vehicle;
(c) converting vehicle data into first partition data to n-th partition data by using the hash key and the encryption key, wherein “n” is an integer equal to or greater than 2; and
(d) transmitting the first partition data to the n-th partition data to the external device,
wherein i-th partition data among the first partition data to the n-th partition data of the vehicle data includes i-th serial number information, an i-th MAC chaining value, i-th payload information, and an i-th MAC tag, wherein “i” is an integer from 1 to n,
if “i” is equal to 1, the i-th MAC chaining value is a predetermined initial value, and if “i” is not equal to 1, the i-th MAC chaining value is generated based on an (i-1)-th MAC chaining value,
the i-th MAC tag is generated by computing at least the i-th MAC chaining value and the i-th payload information by using the hash key and a predetermined MAC generation algorithm, and
the i-th payload information is encrypted by using the encryption key.

13. The method of claim 12, further comprising:
(e) obtaining the vehicle data from an electronic device disposed in the vehicle prior to (c),
wherein the vehicle data is data having a format according to a controller area network (CAN) protocol.

14. The method of claim 12, wherein the predetermined initial value is generated by computing the unique identification information by using the hash key and the MAC generation algorithm, and if “i” is not equal to 1, the i-th MAC chaining value is generated by computing an (i-1)-th MAC chaining value by using the hash key and the MAC generation algorithm.

15. The method of claim 12, wherein if “i” is not equal to 1, the i-th MAC chaining value is an (i-1)-th MAC tag.

16. The method of claim 12, wherein the i-th payload information is encrypted using a stream cipher method.

17. The method of claim 12, wherein the i-th payload information includes a i-th payload and a i-th padding that are being encrypted,
the i-th partition data further includes i-th length information that includes a length of the i-th payload and a length of the i-th padding, and
the i-th MAC tag is generated by computing the i-th MAC chaining value by using the hash key and the predetermined MAC generation algorithm, the i-th length information, and the i-th payload information.

18. The method of claim 12, wherein, in (b), the hash key is generated by computing the multicast key and the unique identification information of the vehicle by using a predetermined key generation algorithm.

19. The method of claim 12, wherein the hash key is the same as the encryption key.

20. The method of claim 12, wherein (a) is performed at a predetermined interval or in response to a predetermined event.
